(19) United States
(12) Patent Application Publication
(10) Pub. No.: US 2010/0001510 A1
(43) Pub. Date: Jan. 7, 2010

(54) METHOD FOR AUTHENTICATING AND/OR IDENTIFYING A SECURITY AND/OR VALUABLE DOCUMENT

(75) Inventors: Sandrine Rancien, La Murette (FR); Sëbastien Charignon, Saint Ondras (FR)

Correspondence Address: OLIFF & BERRIDGE, PLC, P.O. BOX 320850, ALEXANDRIA, VA, 22320-4850, US

(73) Assignee: ARJOWIGGINS SECURITY, ISSY LES MOULINEAUX (FR)

(21) Appl. No.: 12/444,917

(22) PCT Filed: Oct. 31, 2007
(86) PCT No.: PCT/FR2007/052289

§ 371 Date: Jun. 12, 2009

(30) Foreign Application Priority Data
Oct. 31, 2006 (FR) 06 54668

(51) Int. Cl. B42D 15/00; B42D 15/10; B23P 11/00; G07D 7/00

(52) U.S. Cl. 283/103; 283/105; 29/428; 356/71

(57) ABSTRACT

A method for authenticating and/or identifying a security and/or valuable document comprising a sheet material, wherein the sheet material can be physically altered and comprises a substrate, at least one interlaced thread structure at least partially embedded in the substrates, the method comprising the following steps: mechanically altering the sheet material so as to expose a portion at least of the interlaced thread structure, and deducing the authenticity and/or identity of the document at least by observing the exposed portion of the interlaced thread structure.

The present invention relates, in particular, to a method for authenticating and/or identifying a security and/or valuable document, and to a sheet material used to produce such a document.

A security paper is known from Patent Application EP 1 447 474 which can be authenticated by tearing, comprising a layer of paper coated on at least one of its faces with one or more colored layers. The security paper also comprises outer opacifying layers that make it possible to conceal the underlying colored layers. The torn security paper reveals the different colors of the various layers.

Other types of security papers that can be authenticated by tearing are also proposed. These security papers may be produced, for example, from a colored layer of paper covered, especially by coating, on each side with an opaque white layer.

Security papers are also known that are produced from a colored layer of paper, laminated on each side with layers of white paper. These security papers may also be produced from a layer of paper provided with a colored layer pasted with a layer of white paper.

The security papers described above can be authenticated by tearing, revealing one or more colors.

Furthermore known from Patent FR 2 117 055 and Patent Application EP 520 060 are security papers that incorporate a strip that has meshes.

Also known from Patent Application FR 2 873 134 is a sheet material incorporating a knitted structure which may comprise a specific element for authentication and/or identification. The authentication of a document which incorporates such a structure is carried out by the acquisition of at least one characteristic piece of information from the mesh of the knitted structure.

The invention aims to provide a novel method for authenticating and/or identifying a security and/or valuable document incorporating a sheet material.

The expression “sheet material” may denote a fibrous sheet based on cellulose and/or synthetic fibers, having a composite or non-composite single-layer or multilayer structure. A sheet material may, for example, have a relatively small thickness, especially less than or equal to 3 mm, for example equal to around 100 μm, and may be flexible. In one exemplary embodiment of the invention, the sheet material may be stored on a reel, especially before being cut to the desired format.

According to one of the aspects of the invention, the sheet material may be altered physically, the material comprising:
a substrate; and
at least one interlaced yarn structure embedded at least partially in the substrate,
   the method for authentication and/or identification comprising the following steps:
mechanically altering the sheet material so as to make at least one portion of the interlaced yarn structure visible; and
concluding as to the authenticity and/or the identity of the document owing to at least the observation of the visible portion of the interlaced yarn structure.

This observation may be carried out under natural or artificial light, especially under UV or IR lighting.

The invention thus makes it possible to visually authenticate and/or identify a security and/or valuable document, for example by starting a tearing of the document that reveals at least one portion of the interlaced yarn structure. The authentication of the document may also be based at least partially on a tactile effect corresponding to a feeling of resistance during the tearing of the interlaced yarn structure and/or on an auditory effect corresponding to a specific sound emitted during the tearing of the interlaced yarn structure.

The term “yarn” may also denote a strip, for example a flat strip.

In one exemplary embodiment of the invention, the method comprises the following steps:
altering, by tearing, especially by hand, the document so as to make at least one yarn of the interlaced yarn structure visible over at least one portion of the length of this yarn; and
concluding as to the authenticity and/or the identity of the document owing to at least the observation of the visible yarn portion.

This observation may be carried out in daylight under artificial lighting and/or optionally under UV and/or IR light, especially in the case of fluorescence of the yarns.

The document may advantageously be torn first by starting a tear on one edge of the document then by exerting opposing forces substantially in the plane of this document, on both sides of the tear initiation.

This makes it possible to expose yarns of the interlaced yarn structure over a relatively sizeable length.

The method advantageously comprises the following step:
altering the interlaced yarn structure during the tearing of the document, by breaking one or more yarns of the interlaced yarn structure.

The break may reveal, where appropriate, security elements present within the yarns.

In another exemplary embodiment of the invention, the method comprises the following steps:
altering, by punching, the document in a zone of the latter containing at least one portion of the interlaced yarn structure; and
concluding as to the authenticity and/or the identity of the document owing to at least the observation, in the punched zone, of the visible portion of the interlaced yarn structure.

The document has, if desired, a thickness suitable for use in an automatic punching device such as, for example, used for transport tickets.

Another subject of the invention is, according to another of its aspects, a sheet material, especially intended to produce a security and/or valuable document, the sheet material comprising:
a substrate; and
at least one interlaced yarn structure having a width,
   the sheet material being characterized in that it comprises at least one tearable zone, in particular that can be torn by hand, in which the interlaced yarn structure is at least partially embedded in the substrate, and in that the substrate and the interlaced yarn structure are arranged so as to allow tearing of the substrate to be started in the tearable zone, making the interlaced yarn structure visible over at least one portion of its width, especially greater than 1% of its total width, for example being between 5 and 50% of its total width, without however completely altering the interlaced yarn structure, or even without altering it at all.

The structure may thus be partially altered. For example, only the yarns having a first orientation may be altered whereas those having a second orientation, for example perpendicular to the first, may not be altered.

Another subject of the invention is, according to another of its aspects, a sheet material, especially intended to produce a security and/or valuable document, the sheet material comprising:
a substrate; and
at least one interlaced yarn structure,
   the sheet material being characterized in that it comprises at least one tearable zone, in particular that can be torn by hand, in which the interlaced yarn structure is at least partially embedded in the substrate, and in that the substrate and the interlaced yarn structure are arranged so that, when the sheet material is completely torn, at least one yarn of the interlaced yarn structure becomes visible, over at least one portion of its length, in particular over a length of at least 1 mm, for example between 2 and 10 mm.

In one exemplary embodiment of the invention, the interlaced yarn structure has a tear strength greater than that of the substrate, for at least one tear direction. The interlaced yarn structure advantageously has a surface finish chosen so as to allow the material of the substrate to slide over the interlaced yarn structure, at least over one portion of this structure, when the sheet material is torn. The yarns have, for example, a smooth outer surface and may have adjuvants that favor the sliding such as a charge of PTFE or graphite particles or be sheathed with a coating that favors the sliding, such as a coating comprising PTFE or a lubricant. The yarns may be treated individually before forming the structure. The treatment that aims to favor the sliding, which may be a surface treatment, may also be applied to the entire, already made structure.

During a mechanical alteration of the document, the substrate, especially made of paper, firstly tears and slides over the interlaced yarn structure, on each side of the tear, baring yarns of the structure, over at least one portion of their length.

The substrate may be produced from a fibrous material, in particular that contains cellulose fibers.

The substrate comprises, where appropriate, two assembled plies of paper, the interlaced yarn structure being interposed between the two plies.

In one exemplary embodiment of the invention, the two plies are assembled using an adhesive. In another exemplary embodiment, the interlaced yarn structure may be embedded in the substrate during the formation of the latter, which may be a single-ply substrate.

The interlaced yarn structure may especially comprise at least one portion chosen from: a woven portion, a lace portion, a knitted portion, a grid portion and a sewn portion.

The term “lace” may denote a very openwork structure with no weft or warp and mostly having relatively solid and/or opaque patterns, and which may optionally have one edge substantially in the form of teeth.

In one exemplary embodiment of the invention, the interlaced yarn structure extends over one part only of the surface of the substrate and has, for example, a strip shape.

As a variant, the interlaced yarn structure extends over the entire surface of the substrate.

The sheet material may comprise, where appropriate, weakening means that make it possible to facilitate a tear, the weakening means comprising, in particular, at least one cut, made with or without removal of material.

when the interlaced yarn structure can be torn by hand, it comprises, in particular, at least one yarn that can be broken by exerting opposing forces on two portions of this yarn.

Advantageously, the interlaced yarn structure comprises at least two yarns of different colors, which makes it possible to improve the security of the document against a forgery attempt and to facilitate the visual authentication and/or identification.

The interlaced yarn structure may comprise at least two yarns of different natures, with for example different magnetic properties.

The interlaced yarn structure comprises, for example, at least one yarn made of plastic, in particular made of polyester.

The interlaced yarn structure also comprises, for example, at least one yarn made from a material chosen from the following: metal, fiber, aramid (aromatic polyamide, for example Kevlar®, Twaron®), carbon, cellulose, wool, inter alia.

The cross section of at least one yarn of the interlaced yarn structure may be of variable shape, for example square, oval, rectangular, triangular, circular or star shaped. The interlaced yarn structure may comprise at least two yarns of different cross section, for example having different shapes and/or different diameters.

The interlaced yarn structure may comprise at least one yarn having one or more variations in cross section, for example a variation in the diameter of the cross section along the yarn and/or a variation in the shape of the cross section along the yarn. In one exemplary embodiment of the invention, the interlaced yarn structure comprises at least one security element, in particular that can be detected by an appropriate detection device, the security element comprising, in particular, at least one marker that has specific optical, for example IR or UV fluorescence, or biological or chemical, magnetic or electromagnetic properties.

The security element may be present in all the yarns of the structure or only in some of them.

The security element may be present in the bulk of the yarns, in their core only or at the surface only, for example.

In one exemplary embodiment of the invention, the interlaced yarn structure has a thickness between 10 μm and 100 μm, in particular between 30 μm and 80 μm, being in particular in the vicinity of 55 μm.

The interlaced yarn structure may comprise voids formed between the yarns, these voids having an average individual surface area between 1 mm² and 50 mm², in particular between 5 mm² and 20 mm², for example being in the vicinity of 9 mm².

The sheet material may comprise only layers or plies, especially of paper, having an identical color, contrary, in particular, to the security paper described in Patent Application EP 1 447 474, which comprises layers of different colors.

Another subject of the invention is, according to another of its aspects, a sheet material, especially arranged in order to be used to produce a security and/or valuable document, the sheet material comprising:
a substrate; and
at least one interlaced yarn structure comprising at least one lace portion, the structure being at least partially embedded in the substrate.

Another subject of the invention is, according to another of its aspects, a security and/or valuable document incorporating a sheet material as defined above.

The document may constitute one of the following elements: a ticket such as an entrance ticket, a transport ticket or an event ticket, a document having a fiduciary value intended for example to be exchanged, especially a voucher, this list not being exhaustive.

Another subject of the invention is, according to another of its aspects, a method of manufacturing a sheet material comprising:
a substrate; and
at least one interlaced yarn structure comprising at least one yarn which may be broken manually by exerting opposing forces on two portions of this yarn,
   the method comprising the following step:
incorporating the interlaced yarn structure within the substrate.

In one exemplary embodiment of the invention, the method comprises the following steps:
producing two plies of paper, especially on two different paper-making machines; and
assembling the two plies of paper with the interlaced yarn structure interposed between these plies.

The method may comprise the following step:
laminating at least one of the two plies with an adhesive film, especially a pressure-sensitive adhesive or heat-activated adhesive, the interlaced yarn structure coming into contact with the adhesive film.

As a variant, the method comprises the following steps:
assembling the two plies of paper with the interlaced yarn structure by pasting, especially by using a liquid adhesive.

The invention will be better understood on reading the detailed description which follows and the non-limiting exemplary embodiments of the invention, and in examining the appended drawings, in which:

FIG. 1 represents, schematically and partially, a document according to the invention;

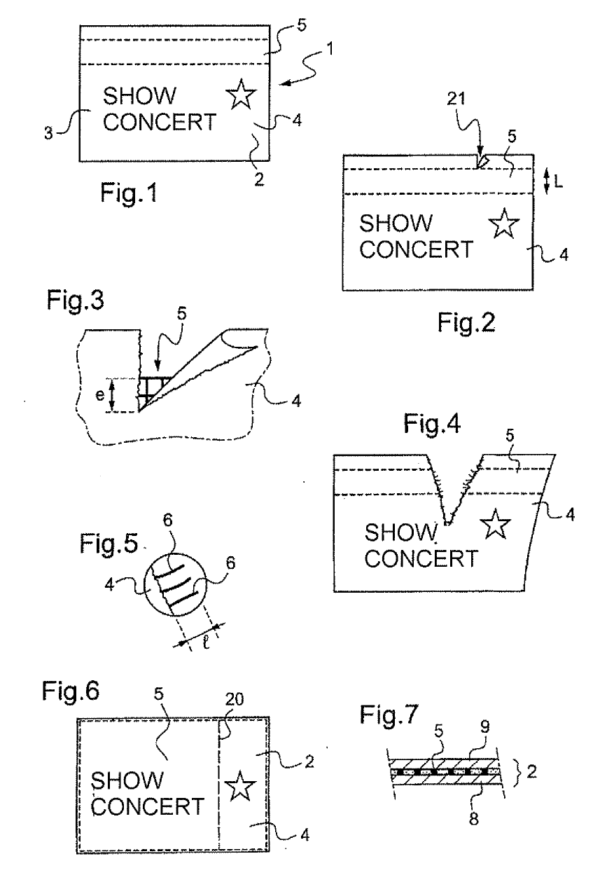

FIGS. 2 to 5 schematically illustrate steps of tearing the document from FIG. 1, with a view to authentication, FIGS. 3 and 5 being enlarged views;

FIG. 6 represents, schematically and partially, a document according to another exemplary embodiment of the invention;

FIG. 7 is a schematic and partial cross section of the document from FIG. 1;

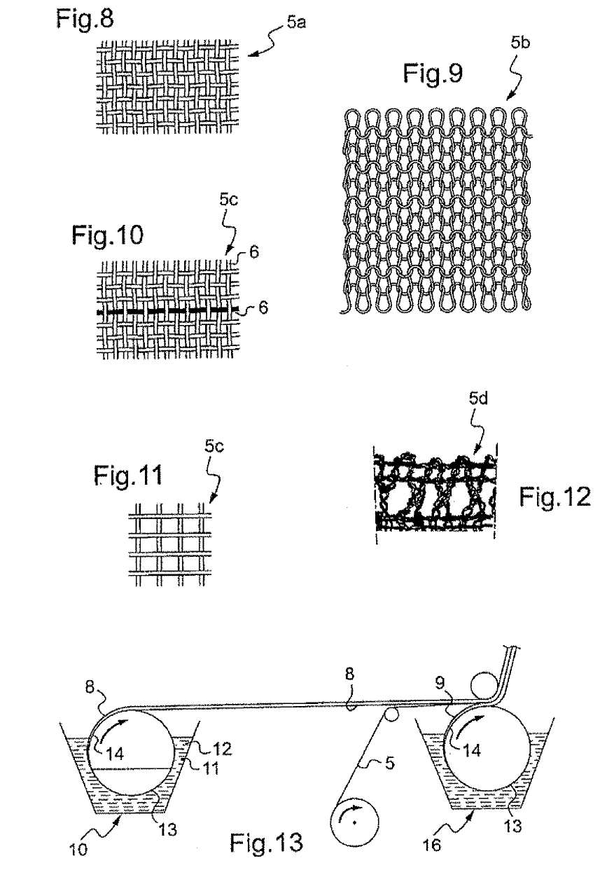

FIGS. 8 to 12 represent, schematically and partially, various examples of interlaced yarn structures; and

FIG. 13 schematically illustrates one step of a method for manufacturing a sheet material according to the invention.

In the drawings, for reasons of clarity, the relative proportions of the various elements represented have not always been respected, the views being schematic.

Represented in FIG. 1 is a security and/or valuable document 1, comprising a sheet material 2 that receives elements 3, for example printed words or designs.

The material 2 comprises a substrate 4 and an interlaced yarn structure 5 embedded in the substrate 4. The interlaced yarn structure 5 may be designed and arranged in order to be invisible to the naked eye when the document 2 is observed in reflection.

The interlaced yarn structure 5 may be a woven structure 5a (see FIG. 8), a knitted structure 5b (see FIG. 9) a grid 5c (see FIG. 11) or a lace structure 5d (see FIG. 12).

The structure 5, for example the grid 5c, may comprise yarns 6 of different colors, as illustrated in FIG. 10, the sequence of colors formed by the yarns of the structure possibly constituting a code.

If desired, the interlaced yarn structure 5 comprises at least two yarns of different natures, for example with different magnetic properties.

One of the yarns 6 may, for example, be a luminescent, fluorescent or phosphorescent yarn or comprise any other agent sensitive to an external stimulus, for example an agent that gives a colored reaction in daylight, a photochromic or piezochromic, electrochromic or solvatochromic agent.

The structure 5 may comprise, if desired, at least one element for authentication and/or identification chosen from at least one of the following elements: an element for highlighting a forgery, in particular that can be seen and/or detected using a specific detection device, an element having a variable, interference and/or diffractive, iridescent or liquid-crystal optical effect, a magnetic or crystalline coating, magnetic fibers, markers that can be detected by magnetic resonance, markers that can be detected by X-ray fluorescence, biomarkers, a varnish or an ink, luminescent (fluorescent or phosphorescent) markers, photochromic, thermochromic, electroluminescent and/or piezochromic compounds and/or compounds that change color in contact with one or more of the products given above.

The element may only become visible, where appropriate, after tearing of the structure.

The interlaced yarn structure 5 can be torn manually, the yarn 6 possibly being broken by exerting opposing forces on two portions of one yarn. In the example from FIG. 1, the structure 5 extends over one part only of the surface of the substrate 4 and has a strip shape with a width less than the width of the substrate 4.

As a variant, as illustrated in FIG. 6, the interlaced yarn structure 5 extends over the entire surface of the substrate 4.

In the examples described, the substrate 4 comprises two plies of paper 8 and 9 between which the interlaced yarn structure 5 is interposed, as illustrated in FIG. 7.

The sheet material 2 may be manufactured in the following manner (see FIG. 13).

The ply of paper 8 is formed on a first paper-making machine 10 having a round shape, comprising a tank 11 containing a suspension 12 of fibers, for example of cellulose fibers, in which a rotating wire roll 13 is partly submerged defining a surface 14 in contact with which the ply 8 is formed continuously.

The ply of paper 9 is formed on a second paper-making machine 16 having a round shape, identical to the first machine 10.

The two plies 8 and 9 are assembled by pasting using a liquid adhesive after introducing the interlaced yarn structure 5 between these plies 8 and 9.

As a variant, the paper plies 8 and 9 are assembled using an adhesive film.

### Example of a Sheet Material 2 According to the Invention

The interlaced yarn structure 5 is a grid 5c formed from polyester yarns. This grid 5c is, for example, a grid sold by Chavanoz Industrie under the reference GC3943/18, having a density of around 6.8 g/m² and a thickness of around 55 μm. This grid 5c is interposed between the plies of paper 8 and 9 respectively having densities of 50 and 35 g/m². The grid 5c defines, between the yarns, voids of substantially square shape having dimensions around 3 mm×3 mm.

The document 1 may be an entrance ticket for a cinema for example as illustrated in FIG. 1.

As a variant, the document 1 may be constituted by a transport ticket or an event ticket, or else a document having a fiduciary value intended for example to be exchanged, especially a voucher.

The document 1 may be authenticated and/or identified by tearing it manually.

As illustrated in FIGS. 2 and 3, a tear initiation 21 of the substrate 4 makes the interlaced yarn structure visible over one portion e of its width, without however altering the structure 5.

By continuing to tear the document 1, as illustrated in FIGS. 4 and 5, by exerting opposing forces substantially in the plane of the document 1, on both sides of the tear initiation 21, the structure 5 is altered by breaking yarns 6 of this structure, so as to make these broken yarns 6 visible over at least one portion 1 of their length.

As illustrated in FIG. 6, the sheet material 2 may comprise weakening means 20 that make it possible to facilitate the tearing of the sheet material 2, the weakening means comprising, for example, at least one cut, made with or without removing material.

The document 1 may be authenticated, as a variant, by punching.

The expression “comprising one” should be understood as being synonymous with “comprising at least one”, unless indicated otherwise.

1-29. (canceled)

30. A method of authenticating and/or of identifying a security and/or valuable document incorporating a sheet material, the sheet material possibly being altered physically, the method comprising:
mechanically altering a sheet material having a substrate and at least one interlaced yarn structure embedded at least partially in the substrate, so as to make at least one portion of the interlaced yarn structure visible; and
concluding as to an authenticity and/or an identity of the document owing to at least an observation of the at least one visible portion of the interlaced yarn structure.

31. The method of claim 30, further comprising:
altering, by tearing, the document so as to make at least one yarn of the interlaced yarn structure visible over at least one portion of its length; and
concluding as to the authenticity and/or the identity of the document owing to at least the observation of the visible yarn portion.

32. The method of claim 31, wherein the tearing is performed by hand.

33. The method of claim 31, further comprising:
altering the interlaced yarn structure during the tearing of the document, by breaking one or more yarns of the interlaced yarn structure.

34. The method as claimed in claim 30, further comprising:
altering, by punching, the document in a zone of the document containing at least one portion of the interlaced yarn structure; and
concluding as to the authenticity and/or the identity of the document owing to at least the observation, in the punched zone, of the visible portion of the interlaced yarn structure.

35. A sheet material for use in production of a security and/or valuable document, the sheet material comprising:
a substrate;
at least one interlaced yarn structure having a total width (L); and
at least one tearable zone that can be torn by hand,
wherein the interlaced yarn structure is at least partially embedded in the substrate, and
the substrate and the interlaced yarn structure are configured so as to allow tearing of the substrate to be started in the tearable zone, making the interlaced yarn structure visible over at least one portion of its width.

36. The sheet material of claim 35, wherein the at least one portion is greater than 1 percent of the total width (L).

37. The sheet material of claim 35, wherein the at least one portion is between 5 percent and 50 percent of the total width (L).

38. The sheet material of claim 35, wherein the interlaced yarn structure is visible over at least one portion of its width prior to alteration of the sheet material.

39. The sheet material of claim 35, wherein the interlaced yarn structure is only visible over at least one portion of its width following a partial alteration of the sheet material.

40. The sheet material as claimed in claim 35, wherein the interlaced yarn structure has a tear strength greater than that of the substrate, for at least one tear direction.

41. The sheet material of claim 35, wherein the interlaced yarn structure has a surface finish chosen so as to allow the material of the substrate to slide over at least a portion of the interlaced yarn structure when the sheet material is torn.

42. The sheet material as claimed in claim 41, the structure wherein the surface finish comprises a lubricant.

43. The sheet material as claimed in claim 42, wherein the surface finish is PTFE.

44. The sheet material as claimed in claim 35, wherein the substrate comprises a fibrous material.

45. The sheet material of claim 44, wherein the fibrous material comprises cellulose fibers.

46. The sheet material of claim 45, wherein the substrate comprises two assembled plies of paper, the interlaced yarn structure being interposed between the two plies.

47. The sheet material of claim 46, wherein the two plies are assembled using an adhesive.

48. The sheet material of claim 35, wherein the interlaced yarn structure comprises at least one portion chosen from: a woven portion, a lace portion, a knitted portion, a grid portion, and a sewn portion.

49. The sheet material as claimed in claim 35, wherein the interlaced yarn structure extends over one part only of the surface of the substrate.

50. The sheet material as claimed in claim 35, wherein the interlaced yarn structure has a strip shape.

51. The sheet material as claimed in claim 35, wherein the interlaced yarn structure extends over an entire surface of the substrate.

52. The sheet material as claimed in claim 35, further comprising at least one weakened area facilitating the tearing of the sheet material.

53. The sheet material as claimed in claim 35, wherein the interlaced yarn structure can be torn by hand, the interlaced yarn structure comprising at least one yarn that can be broken by exerting opposing forces on two portions of the yarn.

54. The sheet material as claimed in claim 35, wherein the interlaced yarn structure comprises at least two yarns having at least one different characteristic from one another.

55. The sheet material as claimed in claim 54, wherein the at least one different characteristic is color.

56. The sheet material as claimed in claim 54, wherein the at least one different characteristic is a magnetic property.

57. The sheet material as claimed in claim 35, wherein the interlaced yarn structure comprises at least one yarn made of plastic.

58. The sheet material of claim 57, wherein the plastic is a polyester.

59. The sheet material as claimed in claim 35, wherein the interlaced yarn structure comprises at least one security element that can be detected by a detection device.

60. The sheet material of claim 59, wherein the security element comprises at least one marker that has at least one of a specific biological property, a specific chemical property, a specific optical property, a specific magnetic property, and a specific electromagnetic property.

61. The sheet material as claimed in claim 35, wherein the interlaced yarn structure has a thickness between 10 μm and 100 μm.

62. The sheet material of claim 35, wherein the interlaced yarn structure has a thickness between 30 μm and 80 μm.

63. The sheet material of claim 35, wherein the interlaced yarn structure has a thickness of approximately 55 μm.

64. The sheet material of claim 35, wherein the interlaced yarn structure comprises voids formed between the yarns, these voids having an average individual surface area between 1 mm² and 50 mm².

65. The sheet material of claim 64, wherein the voids have an average individual surface area between 5 mm² and 20 mm².

66. The sheet material of claim 64, wherein the voids have an average individual surface area of approximately 9 mm².

67. The sheet material of claim 35, wherein the sheet material comprises only layers or plies having an identical color.

68. The sheet material of claim 67, wherein the plies comprise paper.

69. A security and/or valuable document incorporating the sheet material as claimed in claim 35.

70. The document of claim 69, wherein the document is chosen from one of the following elements: a ticket and a fiduciary document having a value and intended for exchange.

71. The document of claim 70, wherein the ticket is selected from one of an entrance ticket, a transport ticket, and an event ticket.

72. The document of claim 70, wherein the fiduciary document is a voucher.

73. A sheet material, intended for producing a security and/or valuable document, the sheet material comprising:
a substrate;
at least one interlaced yarn structure; and
at least one tearable zone that can be torn by hand,
wherein the interlaced yarn structure is at least partially embedded in the substrate, and
wherein the substrate and the interlaced yarn structure are configured so that, when the sheet material is completely torn, at least one yarn of the interlaced yarn structure becomes visible over at least a portion of its length.

74. A sheet material, configured to be used to produce a security and/or valuable document, the sheet material comprising:
a substrate; and
at least one interlaced yarn structure comprising at least one lace portion, the interlaced yarn structure being at least partially embedded in the substrate.

75. A method of manufacturing a sheet material, the sheet material comprising:
incorporating within a substrate, an interlaced yarn structure comprising at least one yarn which may be broken manually by exerting opposing forces on two portions of this yarn.
